(19) United States
(12) Patent Application Publication
(10) Pub. No.: US 2025/0034676 A1
(43) Pub. Date: Jan. 30, 2025

(54) OXIDATIVE AND REDUCTIVE LEACHING METHODS

(71) Applicant: BASF SE, Ludwigshafen am Rhein (DE)

(72) Inventors: Vincent Smith, Midrand (ZA); Till Gerlach, Ludwigshafen (DE); Bernard Muller, Midrand (ZA); Wolfgang Rohde, Ludwigshafen (DE); Nils-Olof Joachim Born, Ludwigshafen (DE); Kerstin Schierle-Arndt, Ludwigshafen (DE); Mark Jablonka, Yokneam (IL); Alex Syrma, Yokneam (IL)

(73) Assignee: BASF SE, Ludwigshafen am Rhein (DE)

(21) Appl. No.: 18/717,133

(22) PCT Filed: Dec. 6, 2022
(86) PCT No.: PCT/EP2022/084662

§ 371 Date: Jun. 6, 2024

(30) Foreign Application Priority Data
Dec. 7, 2021 (EP) 21212957.1

(51) Int. Cl. C22B 7/00; C22B 1/02; C22B 3/00; C22B 47/00; H01M 10/54

(52) U.S. Cl. CPC C22B 7/007; C22B 1/02; C22B 23/043; C22B 47/00; H01M 10/54

(57) ABSTRACT

Disclosed herein are methods for leaching a material comprising one or more metals in a zero oxidation state and one or more chosen from metal oxides, metal hydroxides, and combinations thereof, wherein the method comprises contacting the material with an oxidizing acidic aqueous solution having a pH less than 6, and subsequently reducing the one or more chosen from metal oxides, metal hydroxides, and combinations thereof with a reducing agent. Also disclosed are methods comprising leaching a material to obtain an aqueous solution comprising metal ions, and separating the metal ions to obtain at least one essentially pure metal ion solution and/or at least one essentially pure solid metal ion salt. Further disclosed are methods comprising mechanically comminuting a material to obtain a black mass, and leaching the black mass.

### FIELD OF THE INVENTION

The present disclosure relates to processes for removing lithium from materials such as, for example, a battery material, and processes for recycling lithium ion battery materials.

### BACKGROUND

High purity lithium is a valuable resource. Many sources of lithium, such as lithium ion batteries, lithium ion battery waste, lithium containing water, e.g. ground water, and raw lithium containing ores, are complex mixtures of various elements and compounds. The removal and purification of lithium from a material, such as a lithium ion battery material, are exemplary steps in the recycling of lithium ion batteries. Lithium ion battery materials are complex mixtures of various elements and compounds, and it may be desirable to remove various non-lithium impurities. Such impurities may exist in a variety of oxidation states which may impact, for example, the efficiency of a leaching process. For example, in some leaching processes high oxidation state metals may be more or less efficiently leached than low or zero oxidation state metals. Some non-lithium impurities are also valuable resources, and it may additionally be desirable to separate and purify various elements and compounds from such materials.

Accordingly, there is a need for processes for removing lithium from materials such as, for example, a battery material, and for processes for recycling lithium ion battery materials. For example, there is a need for leaching methods for efficiently and effectively leaching complex mixtures of various elements and compounds such as, for example, mixed metals coexisting in a variety of oxidation states. For example, there is a need for economic processes with high lithium recovery and high lithium purity. There is also a need for economic processes with high recovery and high purity for removing value metals such as, for example, nickel and cobalt, from materials.

WO 2021/174348 A1 discloses a method for processing a black mass material from lithium iron phosphate batteries comprising a) receiving a black mass material feed material; b) acid leaching the black mass material at a pH that is less than 4, thereby producing a pregnant leach solution (PLS) comprising at least 80% of the lithium from the black mass feed material, and at least a portion of the iron and the phosphorous from the black mass feed material; providing a first intermediary solution after completing step b); and separating at least 90% of the iron and the phosphorous from the first intermediary solution to provide an output solution.

WO 2020/212587 A1 discloses a process for the recovery of metals such as Ni and Co from a Li-containing starting material, comprising the steps of: Step 1: Providing said starting material, comprising Li-ion batteries or their derived products; Step 2: Removing Li in an amount of more than the maximum of (1) 30% of the Li present in said starting material, and (2) a percentage of the Li present in said starting material determined to obtain a Li:M ratio of less than 0.70 in a subsequent acidic leaching step; Step 3: Subsequent leaching using relative amounts of Li-depleted product and a mineral acid, thereby obtaining a Ni- and Co-bearing solution; and, Step 4: Crystallization of Ni, Co, and optionally Mn.

### SUMMARY OF THE INVENTION

Disclosed herein are methods for leaching a material comprising one or more metals in a zero oxidation state and one or more chosen from metal oxides, metal hydroxides, and combinations thereof, wherein the method comprises contacting the material with an oxidizing acidic aqueous solution having a pH less than 6, and, subsequently reducing the one or more chosen from metal oxides, metal hydroxides, and combinations thereof with a reducing agent. Also disclosed are methods comprising leaching a material to obtain an aqueous solution comprising metal ions, and separating the metal ions to obtain at least one essentially pure metal ion solution and/or at least one essentially pure solid metal ion salt. Further disclosed are methods comprising mechanically comminuting at least one material chosen from a lithium ion battery, lithium ion battery waste, lithium ion battery production scrap, lithium ion cell production scrap, lithium ion cathode active material, and combinations thereof to obtain a black mass, and leaching the black mass.

### BRIEF DESCRIPTION OF THE DRAWINGS

FIG. 1 depicts an exemplary batch process consistent with some embodiments of the disclosure;

FIG. 2 depicts an exemplary continuous process consistent with some embodiments of the disclosure;

FIG. 3 depicts an XRD pattern of an exemplary black mass.

### DETAILED DESCRIPTION

Disclosed herein are methods for leaching a material comprising one or more metals in a zero oxidation state and one or more chosen from metal oxides, metal hydroxides, and combinations thereof, wherein the method comprises contacting the material with an oxidizing acidic aqueous solution having a pH less than 6, and, subsequently reducing the one or more chosen from metal oxides, metal hydroxides, and combinations thereof with a reducing agent.

The oxidizing acidic aqueous solution comprises at least one acid chosen from HCl, H₂SO₄, CH₃SO₃H, HNO₃, and combinations thereof. The oxidizing acidic aqueous solution further comprises one or more chosen from O₂, N₂O, and combinations thereof.

In some embodiments, the oxidizing acidic aqueous solution comprises H₂SO₄. In some embodiments, the oxidizing acidic aqueous solution comprises H₂SO₄ and O₂. In some embodiments, the oxidizing acidic aqueous solution comprises O₂ and the O₂ is provided as air. In some embodiments, the air comprises less than or equal to 3 volume % sulfur dioxide.

In some embodiments, contacting the material with an oxidizing acidic aqueous solution having a pH less than 6 causes a formation of hydrogen gas, and an oxidizing agent chosen from O₂ (e.g., air), N₂O, and combinations thereof is added after the formation of hydrogen gas.

In some embodiments, the oxidizing acidic aqueous solution further comprises hydrogen peroxide, provided that the one or more chosen from metal oxides or metal hydroxides comprising nickel cobalt or manganese contain these metals in an oxidation state of +2.

In some embodiments, the oxidizing acidic aqueous solution comprises less than 1 part by weight H₂O₂ per 1000 parts by weight of the material.

In some embodiments, the one or more chosen from metal oxides or metal hydroxides comprising nickel, cobalt, or manganese contain these metals in an oxidation state of +2 in an amount ranging from 5 weight % to 10 weight %, 10 weight % to 20 weight %, or 20 weight % to 50 weight %, relative to the total weight of the one or more chosen from metal oxides or metal hydroxides comprising nickel, cobalt, or manganese.

In some embodiments, the acidic aqueous solution has a concentration of acid ranging from 18 mol/L to 0.0001 mol/L.

The reducing agent is one or more chosen from SO₂, metabisulfite salts, bisulfite salts, thiosulfate salts, H₂O₂, H₂, and combinations thereof.

In some embodiments, the reducing agent comprises less than 1 mol % H₂O₂ by total moles of the reducing agent.

In some embodiments, the method further comprises adding an additional metal oxide and/or metal hydroxide after the contacting step and before the reducing step.

The method for leaching a material comprising one or more metals in a zero oxidation state and one or more chosen from metal oxides, metal hydroxides, and combinations thereof comprises: contacting the material with an acidic aqueous means for oxidizing the one or more metals in a zero oxidation state, and subsequently treating the material with a means for reducing the one or more chosen from metal oxides, metal hydroxides, and combinations thereof.

The acidic aqueous means for oxidizing the one or more metals in a zero oxidation state is an oxidizing acidic aqueous solution. The acidic aqueous means for oxidizing the one or more metals in a zero oxidation state comprises an oxidizing agent. In some embodiments, the oxidizing agent has a standard electrode potential ranging from +0.1 V to +1.5 V. In some embodiments, the oxidizing agent has a standard electrode potential ranging from +1 V to +1.5 V.

The means for reducing the one or more chosen from metal oxides, metal hydroxides, and combinations thereof comprises a reducing agent. In some embodiments, the reducing agent has a standard electrode potential ranging from +1 V to −0.5 V. In some embodiments, the reducing agent has a standard electrode potential ranging from +0.2 V to −0.3 V.

In some embodiments, the method is a method for leaching a material comprising one or more of lithium, copper, nickel, cobalt, and manganese, and comprises: contacting the material with an acidic aqueous solution comprising H₂SO₄, sparging an oxidizing agent comprising O₂ through the acidic aqueous solution, and subsequently sparging a reducing agent comprising SO₂ through the acidic aqueous solution.

In some embodiments, the method further comprises adding an additional material comprising one or more chosen from metal oxides, metal hydroxides, and combinations thereof subsequent to the contacting step. In some embodiments, the method comprises adding an additional metal oxide and/or metal hydroxide after the contacting step and before the reducing step.

Also disclosed are methods comprising leaching a material to obtain an aqueous solution comprising metal ions, and separating the metal ions to obtain at least one essentially pure metal ion solution and/or at least one essentially pure solid metal ion salt.

Further disclosed are methods comprising mechanically comminuting at least one material chosen from a lithium ion battery, lithium ion battery waste, lithium ion battery production scrap, lithium ion cell production scrap, lithium ion cathode active material, and combinations thereof to obtain a black mass, and leaching the black mass.

In some embodiments, a disclosed method comprises subjecting the at least one material to a heat treatment step.

### Definitions

As used herein, “a” or “an” entity refers to one or more of that entity, e.g., “a compound” refers to one or more compounds or at least one compound unless stated otherwise. As such, the terms “a” (or “an”), “one or more”, and “at least one” are used interchangeably herein.

As used herein, the term “material” refers to the elements, constituents, and/or substances of which something is composed or can be made.

As used herein, a “reducing agent” is a compound capable of reducing a metal oxide and/or a metal hydroxide. For example, some reducing agents are capable of reducing some metal oxides and/or some metal hydroxides but not others.

As used herein, an “oxidizing acidic aqueous solution” is an aqueous solution having a pH less than 7 capable of oxidizing a metal in a zero oxidation state. For example, some oxidizing acidic aqueous solutions are capable of oxidizing some metals in a zero oxidation state but not others.

As used herein, an “oxidizing agent” is a compound capable of oxidizing a metal in a zero oxidation state. For example, some oxidizing agents are capable of oxidizing some metals in a zero oxidation state but not others.

As used herein, a “solution” is a combination of a fluid and one or more compounds. For example, each of the one or more compounds in the solution may or may not be dissolved in the fluid.

As used herein, an “essentially pure metal ion solution” is a solution comprising a metal ion, a counter ion, a solvent; wherein the total weight of the metal ion and counter ion is at least 50% by weight excluding the weight of solvent.

As used herein, an “essentially pure solid metal ion salt” is a solid comprising a metal ion and a counter ion; wherein the total weight of the metal ion and counter ion is at least 50% by weight of the solid excluding the weight of solvent.

As used herein, the term “sparging” refers to dispersing a gas through a liquid.

As used herein, the term “base” refers to a material capable of reacting with a hydronium ion and to increase the pH-value of an acidic solution.

As used herein, the term “standard electrode potential” has its common usage in the field of electro-chemistry and is the value of the electromotive force of an electrochemical cell in which molecular hydrogen under at 1 bar and 298.15 K is oxidized to solvated protons at the standard hydrogen electrode. The potential of the standard hydrogen electrode is zero Volts by definition. An exemplary reference is: Johnstone, A. H. “CRC Handbook of Chemistry and Physics—69th Edition Editor in Chief RC Weast, CRC Press Inc., Boca Raton, Florida, 1988.

As used herein, gas volumes and flow rates recited refer to values at standard temperature and pressure, i.e., at 0° C. and 1013 hPa.

### Materials:

The material comprises one or more metals in a zero oxidation state and one or more chosen from metal oxides, metal hydroxides, and combinations thereof.

In some embodiments, the material comprises one or more chosen from nickel, cobalt, manganese, and combinations thereof.

In some embodiments, the one or more metals in a zero oxidation state is chosen from nickel, cobalt, copper, aluminum, iron, manganese, rare earth metals, and combinations thereof.

In some embodiments, the metal oxides are chosen from nickel oxides, cobalt oxides, copper oxides, aluminum oxide, iron oxides, manganese oxides, rare earth oxides, and combinations thereof.

In some embodiments, the metal hydroxides are chosen from nickel hydroxides, cobalt hydroxides, copper hydroxides, aluminum hydroxide, iron hydroxides, manganese hydroxides, rare earth hydroxides, and combinations thereof.

In some embodiments, the material comprises: from 0.1 weight percent to 10 weight percent lithium, from 0 weight percent to 60 weight percent nickel, from 0 weight percent to 20 weight percent cobalt, from 0 weight percent to 20 weight percent copper, from 0 weight percent to 20 weight percent aluminum, from 0 weight percent to 20 weight percent iron, and from 0 weight percent to 20 weight percent manganese; wherein each weight percent is by total weight of the material. In some embodiments, the content of at least one of nickel, cobalt, and manganese is more than 0 weight percent.

In some embodiments, the material comprises: from 0.1 weight percent to 10 weight percent lithium, from 0 weight percent to 60 weight percent nickel, from 0 weight percent to 20 weight percent cobalt, from 0.1 weight percent to 20 weight percent copper, from 0 weight percent to 20 weight percent aluminum, from 0 weight percent to 20 weight percent iron, and from 0 weight percent to 20 weight percent manganese; wherein each weight percent is by total weight of the material. In some embodiments, the content of at least one of nickel, cobalt, and manganese is more than 0 weight percent.

In some embodiments, the material, or a precursor thereof, is pyrolyzed prior to leaching. In some embodiments, the pyrolysis is performed under an inert atmosphere, an oxidizing atmosphere, a reducing atmosphere, or a combination thereof.

In some embodiments, the material has a weight ratio ranging from 0.01 to 10, 0.01 to 5, 0.01 to 2, or 0.01 to 1 of lithium to a total weight of nickel, cobalt, manganese, copper, aluminum, iron, and phosphorus.

In some embodiments, the material comprises lithiated nickel cobalt manganese oxide of formula Li₁₊ₓ(NiₐCo_{b}Mn_{c}M1_{d})₁₋ₓO₂, wherein: M1 is chosen from Mg, Ca, Ba, Al, Ti, Zr, Zn, Mo, V and Fe, zero≤x≤0.2, 0.1≤a≤0.95, zero≤b≤0.9, or 0.05<b≤0.5, zero≤c≤0.6, zero≤d≤0.1, and a+b+c+d=1.

In some embodiments, the material comprises lithiated nickel-cobalt aluminum oxides of formula Li[NiₕCoᵢAlⱼ]O_{2+f}, wherein h ranges from 0.8 to 0.95, i ranges from 0.1 to 0.3, j ranges from 0.01 to 0.10, and r ranges from zero to 0.4. In some embodiments, the material comprises lithiated nickel-cobalt aluminum oxides of formula Li[NiₕCoᵢAlⱼ]O_{2+f}, wherein: h ranges from 0.8 to 0.90, i ranges from 0.1 to 0.3, j ranges from 0.01 to 0.10, and r ranges from zero to 0.4.

In some embodiments, the material is a lithium ion battery material comprising one or more chosen from black mass, cathode active material, cathodes, cathode active material precursors, and combinations thereof.

“Black mass” refers to materials comprising lithium derived from, for example, a lithium ion battery, lithium ion battery waste, lithium ion battery production scrap, lithium ion cell production scrap, lithium ion cathode active material, and/or combinations thereof by mechanical processes such as mechanical comminution. For example, black mass may be derived from battery scrap by mechanically treating the battery scrap to obtain the active components of the electrodes such as graphite and cathode active material and may include impurities from the casing, electrode foils, cables, separator, and electrolyte. In some examples, the battery scrap may be subjected to a heat treatment to pyrolyze organic (e.g. electrolyte) and polymeric (e.g. separator and binder) materials. Such a heat treatment may be performed before or after mechanical comminution of the battery material. In some embodiments, the black mass is subjected to a heat treatment.

Lithium ion batteries may be disassembled, punched, milled, for example in a hammer mill, rotor mill, and/or shredded, for example in an industrial shredder. From this kind of mechanical processing the active material of the battery electrodes may be obtained. A light fraction such as housing parts made from organic plastics and aluminum foil or copper foil may be removed, for example, in a forced stream of gas, air separation or classification or sieving.

Battery scraps may stem from, e.g., used batteries or from production waste such as off-spec material. In some embodiments a material is obtained from mechanically treated battery scraps, for example from battery scraps treated in a hammer mill a rotor mill or in an industrial shredder. Such material may have an average particle diameter (D₅₀) ranging from 1 μm to 1 cm, such as from 1 μm to 500 μm, and further for example, from 3 μm to 250 μm.

Larger parts of the battery scrap like the housings, the wiring and the electrode carrier films may be separated mechanically such that the corresponding materials may be excluded from the battery material that is employed in the process.

Mechanically treated battery scrap may be subjected to a solvent treatment in order to dissolve and separate polymeric binders used to bind the transition metal oxides to current collector films, or, e.g., to bind graphite to current collector films. Suitable solvents are N-methylpyrrolidone, N,N-dimethyl-formamide, N,N-dimethylacetamide, N-ethylpyrrolidone, and dimethylsulfoxide, in pure form, as mixtures of at least two of the foregoing, or as a mixture with 1% to 99% by weight of water.

In some embodiments, mechanically treated battery scrap may be subjected to a heat treatment in a wide range of temperatures under different atmospheres. In some embodiments, the temperature ranges from 100° C. to 900° C. In some embodiments, lower temperatures below 300° C. may serve to evaporate residual solvents from the battery electrolyte, at higher temperatures the binder polymers may decompose while at temperatures above 400° C. the composition of the inorganic materials may change as some transition metal oxides may become reduced either by the carbon contained in the scrap material or by introducing reductive gases. In some embodiments, a reduction of lithium metal oxides may be avoided by keeping the temperature below 400° C. and/or by removing carbonaceous materials before the heat treatment.

In some embodiments, the heat treatment is performed at a temperatures ranging from 350° C. to 900° C. In some embodiments, the heat treatment is performed at a temperatures ranging from 450° C. to 800° C. In some embodiments, the heat treatment is performed under an inert, oxidizing, or reducing atmosphere. In some embodiments, the heat treatment is performed under an inert or reducing atmosphere. In some embodiments, reducing agents are formed under the conditions of the heat treatment from pyrolyzed organic (polymeric) components. In some embodiments, reducing agents are formed by adding a reducing gas such as H₂ and/or CO.

In some embodiments, the material comprises at least one chosen from lithiated nickel cobalt manganese oxide, lithiated nickel cobalt aluminum oxide, lithium metal phosphate, lithium ion battery scrap, a black mass, and combinations thereof.

In some embodiments, the material comprises lithium metal phosphate of formula LiₓMPO₄, wherein x is an integer greater than or equal to one, and M is chosen from metals, transition metals, rare earth metals, and combinations thereof.

In some embodiments, the material comprises lithiated nickel cobalt manganese oxide of formula Li₁₊ₓ(NiₐCo_{b}Mn_{c}M1_{d})₁₋ₓO₂, wherein M1 is chosen from Mg, Ca, Ba, Al, Ti, Zr, Zn, Mo, V and Fe, zero≤x≤0.2, 0.1≤a≤0.95, zero≤b≤0.9 (such as 0.05<b≤0.5), zero≤c≤0.6, zero≤d≤0.1, and a+b+c+d=1. Exemplary lithiated nickel cobalt manganese oxides include
Li₍₁₊ₓ₎[Ni_{0.33}Co_{0.33}Mn_{0.33}]₍₁₋ₓ₎O₂,
Li₍₁₊ₓ₎[Ni_{0.5}Co_{0.2}Mn_{0.3}]₍₁₋ₓ₎O₂,
Li₍₁₊ₓ₎[Ni_{0.6}Co_{0.2}Mn_{0.2}]₍₁₋ₓ₎O₂,
Li₍₁₊ₓ₎[Ni_{0.7}Co_{0.2}Mn_{0.3}]₍₁₋ₓ₎O₂,
Li₍₁₊ₓ₎[Ni_{0.8}Co_{0.1}Mn_{0.1}]₍₁₋ₓ₎O₂,
each with x as defined above, and Li[Ni_{0.85}Co_{0.13}Al_{0.02}]O₂.

In some embodiments, the material comprises nickel, cobalt, manganese, copper, aluminum, iron, phosphorus, or combinations thereof.

In some embodiments, wherein the material has a weight ratio ranging from 0.01 to 10 of lithium to a total weight of nickel, cobalt, manganese, copper, aluminum, iron, and phosphorus. In some embodiments, wherein the material has a weight ratio ranging from 0.01 to 5 of lithium to a total weight of nickel, cobalt, manganese, copper, aluminum, iron, and phosphorus. In some embodiments, wherein the material has a weight ratio ranging from 0.01 to 2 of lithium to a total weight of nickel, cobalt, manganese, copper, aluminum, iron, and phosphorus. In some embodiments, wherein the material has a weight ratio ranging from 0.01 to 1 of lithium to a total weight of nickel, cobalt, manganese, copper, aluminum, iron, and phosphorus.

In some embodiments, the material comprises LiₓMO₂, wherein x is an integer greater than or equal to one, and M is chosen from metals, transition metals, rare earth metals, and combinations thereof.

In some embodiments, a process for recycling lithium ion battery materials comprises mechanically comminuting at least one chosen from a lithium ion battery, lithium ion battery waste, lithium ion battery production scrap, lithium ion cell production scrap, lithium ion cathode active material, and combinations thereof to obtain a black mass.

In some embodiments, the material has a standard electrode potential ranging from +1.1 V to −1.7 V. In some embodiments, from 0.1 weight % to 10 weight % of the material has a standard electrode potential ranging from +0.1 V to +0.8 V and from 0.1 weight % to 60 weight % of the material has a standard electrode potential ranging from −1.7 V to −0.01 V; by total weight of the material.

In some embodiments, the one or more metals in a zero oxidation state each have a standard electrode potential ranging from 1.1 V to −1.7 V. In some embodiments, the one or more metals in a zero oxidation state each have a standard electrode potential ranging from −1.7 V to +0.35 V. Standard electrode potentials for some exemplary metals in a zero oxidation state include: Al/Al³⁺ (E(0)=−1.66 V), Cu/Cu²⁺ (E(0)=+0.35 V), Co/Co²⁺ (E(0)=−0.28 V), Fe/Fe²⁺ (E(0)=−0.44 V), and Ni/Ni²⁺ (E(0)=−0.23 V).

In some embodiments, the one or more chosen from metal oxides, metal hydroxides, and combinations thereof each have a standard electrode potential ranging from +0.1 V to +1.9 V. In some embodiments, the one or more chosen from metal oxides, metal hydroxides, and combinations thereof each have a standard electrode potential ranging from 0.15 V to 1.83 V. Standard electrode potentials for some exemplary metal ions such as, for example, metal ions that may result from the dissolution of oxides or hydroxides, and metal oxides and/or metal hydroxides include: Co³⁺/Co²⁺ (E(0)=+1.83 V), NiO₂+4H⁺/Ni²⁺+2H₂O (E(0)=+1.678 V), Mn³⁺/Mn²⁺ (E(0)=+1.5415 V), and Mn(OH)₃/Mn(OH)₂+OH⁻ (E(0)=+0.15 V).

### Leaching:

The method for leaching comprises: contacting the material with an oxidizing acidic aqueous solution having a pH less than 6, and, subsequently, reducing one or more chosen from metal oxides, metal hydroxides, and combinations thereof with a reducing agent. In some embodiments, the material comprises one or more metals in a zero oxidation state and one or more chosen from metal oxides, metal hydroxides, and combinations thereof.

The oxidizing acidic aqueous solution comprises one or more acids chosen from HCl, H₂SO₄, CH₃SO₃H, HNO₃, and combinations thereof. In some embodiments, the oxidizing acidic aqueous solution comprises at least one chosen from H₂SO₄, O₂, N₂O, and combinations thereof. In some embodiments, the oxidizing acidic aqueous solution comprises H₂SO₄. The oxidizing acidic aqueous solution further comprises one or more chosen from O₂, N₂O, and combinations thereof. In some embodiments, the oxidizing acidic aqueous solution comprises an acid that is also an oxidizing agent such as, for example, H₂SO₄. The oxidizing acidic aqueous solution comprises an oxidizing agent that is not an acid such as, for example, O₂, N₂O, or combinations thereof. In some embodiments, the oxidizing acidic aqueous solution comprises an acid and an oxidizing agent. In some embodiments, the oxidizing acidic aqueous solution comprises an acid that is also an oxidizing agent and further comprises an oxidizing agent that is not an acid.

The reducing agent is one or more chosen from SO₂, metabisulfite salts, bisulfite salts, thiosulfate salts, dithionate salts, H₂O₂, H₂, and combinations thereof.

In some embodiments, a black mass is slurred in water at a weight percentage of black mass by total weight of the slurry ranging from 5% to 30%. In some embodiments, the slurred black mass is contacted with the oxidizing acidic aqueous solution having a pH less than 6. In some embodiments, the oxidizing acidic aqueous solution having a pH less than 6 is formed from the slurred black mass by addition of acid and/or an oxidizing agent. In some embodiments, the weight ratio of H₂SO₄ in the oxidizing acidic aqueous to black mass ranges from 1:1 to 2:1. In some embodiments, H₂SO₄ is added to adjust the pH during the contacting step.

In some embodiments, the black mass is provided as a slurry. In some embodiments, the black mass is provided as a slurry in water. In some embodiments, the black mass is provided as a slurry in aqueous side streams from subsequent treatment steps such as, for example, washing liquids from filters. In some embodiments, the black mass is provided as a solid.

In some embodiments, the cathode active material is provided as a slurry. In some embodiments, the cathode active material is provided as a slurry in water. In some embodiments, the cathode active material is provided as a slurry in aqueous side streams from subsequent treatment steps such as, for example, washing liquids from filters. In some embodiments, the cathode active material is provided as a solid.

In some embodiments, the mixed hydroxide precipitate is provided as a slurry. In some embodiments, the mixed hydroxide precipitate is provided as a slurry in water. In some embodiments, the mixed hydroxide precipitate is provided as a slurry in aqueous side streams from subsequent treatment steps such as, for example, washing liquids from filters. In some embodiments, the mixed hydroxide precipitate is provided as a solid.

Contacting the material with an oxidizing acidic aqueous solution is performed at a temperature ranging from 50° C. to 110° C. In some embodiments, contacting the material with an oxidizing acidic aqueous solution is performed for a duration ranging from 2 hours to 4 hours. In some embodiments, contacting the material with an oxidizing acidic aqueous solution is performed at a first temperature and the reducing step is performed at a second temperature, and the second temperature ranges from 70% to 20% of the first temperature (in ° C.).

In some embodiments, the oxidizing acidic aqueous solution comprises air. In some embodiments, the air comprises less than or equal to 3 volume % sulfur dioxide. In some embodiments, contacting the material with an oxidizing acidic aqueous solution having a pH less than 6 comprises sparging air through the oxidizing acidic aqueous solution. In some embodiments, the air is sparged through the oxidizing acidic aqueous solution at a rate of up to 20% solution volume/min. In some embodiments, the air is sparged through the oxidizing acidic aqueous solution at a rate in the range of from 0.1% to 20% solution volume/min. The rate refers to the volume of O₂ being sparged through the oxidizing acidic aqueous solution per minute, i.e., it is equal to approximately 21% of the volume of air being sparged through the solution.

In some embodiments, the oxidizing acidic aqueous solution has a pH ranging from −1.0 to 3.

In some embodiments, contacting the material with an oxidizing acidic aqueous solution having a pH less than 6 comprises first contacting the material with an acid and, subsequently, adding an oxidizing agent chosen from O₂, N₂O, and combinations. In some embodiments, contacting the material with an oxidizing acidic aqueous solution having a pH less than 6 comprises first contacting the material with an acid causing a formation of hydrogen gas and, subsequent to the formation of hydrogen gas (i.e., after the formation of hydrogen gas has subsided), adding an oxidizing agent chosen from O₂, N₂O, and combinations. In some embodiments, contacting the material with an oxidizing acidic aqueous solution having a pH less than 6 comprises first contacting the material with an acid causing a formation of hydrogen gas, monitoring the formation of hydrogen gas by gas chromatography and/or hydrogen sensors, and, subsequent to the formation of hydrogen gas (i.e., after the formation of hydrogen gas has subsided), adding an oxidizing agent chosen from O₂, N₂O, and combinations. In some embodiments, contacting the material with an oxidizing acidic aqueous solution having a pH less than 6 comprises first contacting the material with an acid causing a formation of hydrogen gas, monitoring the formation of hydrogen gas by gas chromatography and/or hydrogen sensors, and, when the concentration of hydrogen gas is less than 5 volume %, for example less than 1 volume % for example less than 0.1 volume %, adding an oxidizing agent chosen from O₂, N₂O, and combinations.

In some embodiments, excess oxidizing gas O₂, such as in air, and/or N₂O is recycled from the off-gas back into the leaching reactor.

In some embodiments, the reducing agent comprises SO₂ and the SO₂ is sparged through the solution at a rate of up to 20% solution volume/min. In some embodiments, the SO₂ is sparged through the solution at a rate in the range of from 0.1% to 20% solution volume/min. In some embodiments, the SO₂ is sparged through the solution for 1 hour to 3 hours.

In some embodiments, the reducing agent comprises SO₂ and the SO₂ is provided as a mixture with O₂ or air containing 10% SO₂ or more. In some embodiments, the reducing agent comprises SO₂ and the SO₂ is not provided as a mixture with O₂ or air. In some embodiments, the reducing agent comprises SO₂ and the SO₂ is provided as pure gas having a purity of at least 90%, for example 99%, or as mixture with an inert gas such as, for example, nitrogen and/or argon.

In some embodiments, the reducing step is performed at ambient temperature.

In some embodiments, subsequent to the contacting step, the method further comprises adding a base. In some embodiments, the base is chosen from CaO, a hydroxide salt, a carbonate salt, and combinations thereof. In some embodiments, the hydroxide salt is chosen from LiOH, NaOH, KOH, NH₄OH, Ca(OH)₂, CaCO₃, Ni(OH)₂, Co(OH)₂, Mn(OH)₂, and combinations thereof.

In some embodiments, the method is performed batchwise.

In some embodiments, the method is performed continuously in at least two reaction vessels. In some embodiments, the method is performed continuously in, e.g., three, four, five, six, seven, or more reaction vessels. In some embodiments, the black mass is added to a first reaction vessel, the oxidizing agent is added to a second and/or a third reaction vessel, the cathode active material and/or mixed hydroxide precipitate is added to a fourth reaction vessel, and the reducing agent is added to a fourth, a fifth, and/or a sixth reaction vessel.

In some embodiments, excess sulfur dioxide is recycled from the off-gas back into the reactor.

In some embodiments, a reflux condenser is fitted to at least one reaction vessel.

In some embodiments, contacting the material with an oxidizing acidic aqueous solution is carried out at ambient pressure. In some embodiments, contacting the material with an oxidizing acidic aqueous solution is carried out at an elevated pressure.

In some embodiments, the contacting step is at a temperature ranging from 20° C. to 100° C. for a duration ranging from 10 minutes to 10 hours, e.g., from 2 hours to 5 hours. In some embodiments, the contacting step is at 100° C. for a duration ranging from 3 hours to 5 hours. In some embodiments, the contacting step is at 60° C. for a duration ranging from 3 hours to 5 hours. In some embodiments, the contacting step is at 25° C. for a duration ranging from 3 hours to 5 hours.

In some embodiments, the reducing step is at a temperature ranging from 20° C. to 100° C. for a duration ranging from 10 minutes to 10 hours, e.g., from 2 hours to 5 hours. In some embodiments, the reducing step is at 100° C. for a duration ranging from 3 hours to 5 hours. In some embodiments, the reducing step is at 60° C. for a duration ranging from 3 hours to 5 hours. In some embodiments, the reducing step is at 25° C. for a duration ranging from 3 hours to 5 hours.

In some embodiments, the method comprising leaching a material is disclosed herein to obtain an aqueous solution comprising metal ions and separating the metal ions to obtain at least one essentially pure metal ion solution and/or at least one essentially pure solid metal ion salt.

In some embodiments, an essentially pure solid metal ion salt is a solid comprising a metal ion and a counter ion; wherein the total weight of the metal ion and counter ion is at least 50% by weight of the solid excluding the weight of solvent such as all water. In some embodiments, an essentially pure solid metal ion salt is a solid comprising a metal ion and a counter ion; wherein the total weight of the metal ion and counter ion is at least 70% by weight of the solid excluding the weight of solvent. In some embodiments, an essentially pure solid metal ion salt is a solid comprising a metal ion and a counter ion; wherein the total weight of the metal ion and counter ion is at least 80% by weight of the solid excluding the weight of solvent. In some embodiments, an essentially pure solid metal ion salt is a solid comprising a metal ion and a counter ion; wherein the total weight of the metal ion and counter ion is at least 90% by weight of the solid excluding the weight of solvent. In some embodiments, an essentially pure solid metal ion salt is a solid comprising a metal ion and a counter ion; wherein the total weight of the metal ion and counter ion is at least 95% by weight of the solid excluding the weight of solvent. In some embodiments, an essentially pure solid metal ion salt is a solid comprising a metal ion and a counter ion; wherein the total weight of the metal ion and counter ion is at least 99% by weight of the solid excluding the weight of solvent.

In some embodiments, an essentially pure metal ion solution is a solution comprising a metal ion, a counter ion, and a solvent; wherein the total weight of the metal ion and counter ion is at least 50% by weight of the solution excluding the weight of solvent. In some embodiments, an essentially pure metal ion solution is a solution comprising a metal ion, a counter ion, a solvent; wherein the total weight of the metal ion and counter ion is at least 70% by weight of the solution excluding the weight of solvent. In some embodiments, an essentially pure metal ion solution is a solution comprising a metal ion, a counter ion, a solvent; wherein the total weight of the metal ion and counter ion is at least 80% by weight of the solution excluding the weight of solvent. In some embodiments, an essentially pure metal ion solution is a solution comprising a metal ion, a counter ion, a solvent; wherein the total weight of the metal ion and counter ion is at least 90% by weight of the solution excluding the weight of solvent. In some embodiments, an essentially pure metal ion solution is a solution comprising a metal ion, a counter ion, a solvent; wherein the total weight of the metal ion and counter ion is at least 95% by weight of the solution excluding the weight of solvent. In some embodiments, an essentially pure metal ion solution is a solution comprising a metal ion, a counter ion, a solvent; wherein the total weight of the metal ion and counter ion is at least 99% by weight of the solution excluding the weight of solvent.

In some embodiments, separating the metal ions to obtain at least one essentially pure metal ion solution and/or at least one essentially pure solid metal ion salt comprises one or more of a solid/liquid separation, an extraction, a precipitation, a crystallization, and combinations thereof.

In some embodiments, the method can be performed in part or in whole as a continuous process controlled by sensors and actuators as part of a computer based process control system.

### Oxidizing Agents:

The oxidizing acidic aqueous solution comprises an oxidizing agent. In some embodiments, an oxidizing agent is an acid such as, for example, H₂SO₄, HNO₃, and combinations thereof. In some embodiments, an oxidizing agent is not an acid such as, for example, O₂, N₂O, and combinations thereof.

In some embodiments, the oxidizing acidic aqueous solution comprises an acid that is not an oxidizing agent and an oxidizing agent that is not an acid. In some embodiments, the oxidizing acidic aqueous solution comprises an acid that is an oxidizing agent and an oxidizing agent that is not an acid. In some embodiments, the oxidizing acidic aqueous solution comprises an acid that is not an oxidizing agent and an oxidizing agent that is an acid. In some embodiments, the oxidizing acidic aqueous solution comprises an acid that is an oxidizing agent and an oxidizing agent that is an acid. In some embodiments, the oxidizing acidic aqueous solution comprises an acid that is an oxidizing agent. In some embodiments, an acidic aqueous solution is an oxidizing acidic aqueous solution. In some embodiments, acidic aqueous solution is not an oxidizing acidic aqueous solution.

In some embodiments, an oxidizing agent has a standard electrode potential ranging from +0.1 V to +1.5 V. In some embodiments, an oxidizing agent has a standard electrode potential ranging from +0.4 V to +1.3 V. In some embodiments, an oxidizing agent has a standard electrode potential ranging from +1 V to +1.5 V.

### Reducing Agents:

The reducing agent is one or more chosen from SO₂, metabisulfite salts, bisulfite salts, dithionate salts, thiosulfate salts, H₂O₂, H₂, and combinations thereof.

In some embodiments, a reducing agent has a standard electrode potential ranging from +1 V to −0.5 V. In some embodiments, a reducing agent has a standard electrode potential ranging from +0.2 V to −0.3 V.

Hydrogen peroxide can function as reductant or oxidant, depending on the reaction partner. Possible oxidation and reduction reactions are: H₂O₂↔O₂+2e⁻+2 H⁺, and H₂O₂+2e⁻+2 H⁺↔2 H₂O. In some embodiments, the standard electrode potential of the reaction partner impacts which reaction occurs. For example, under certain conditions permanganate (MnO₄) is reduced by hydrogen peroxide while Fe²⁺ is oxidized. In some embodiments, more acidic conditions benefit the oxidation reaction as H⁺ is needed to form water and less acidic conditions benefit the reduction reaction as H⁺ is produced during that reaction. In some embodiments, the following reactions may or may not occur depending on the one or more metals M and the conditions used: 2LiMO₂+H₂O₂+3H₂SO₄↔2LiSO₄+2MSO₄+4H₂O+O₂, and M+H₂O₂+H₂SO₄↔MSO₄+2H₂O.

### Exemplary Batch Process:

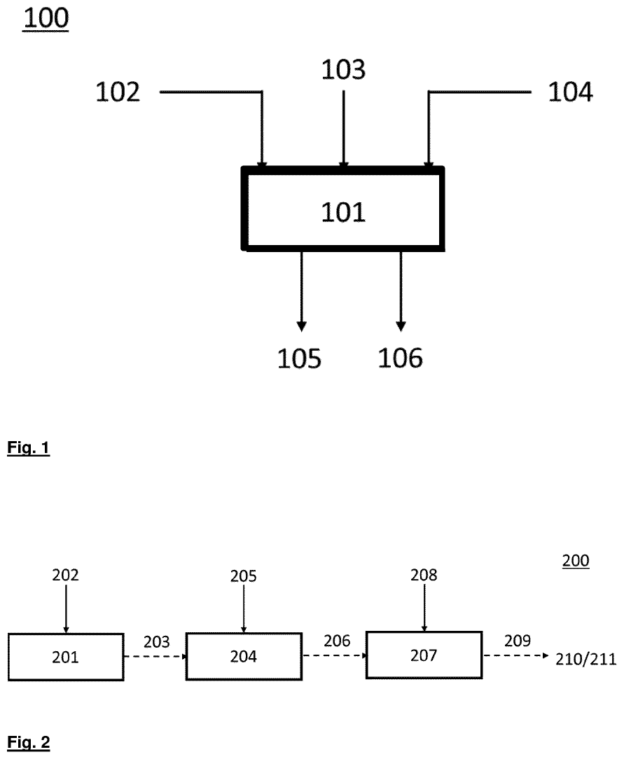

FIG. 1 depicts an exemplary batch process (100) consistent with some embodiments of the disclosure. In some embodiments, a material (102) such as a black mass comprising nickel, cobalt, and manganese species is acid leached in a continuously stirred reaction vessel (101) comprising an acidic aqueous solution at a pH less than 0. In some embodiments, hydrogen gas is evolved (105). In some embodiments, an oxidizing agent such as, for example, O₂ and/or N₂O is added (103). In some embodiments, the pH is adjusted up to a pH ranging from 1 to 2 with, for example, cathode active material and/or mixed hydroxide precipitate and a reducing agent such as, for example, SO₂ is introduced (104). In some embodiments, the obtained liquid phase (106) and a solid phase (105) are separated by a solid/liquid separation e.g. filtration, centrifugation, and/or sedimentation.

### Exemplary Continuous Process:

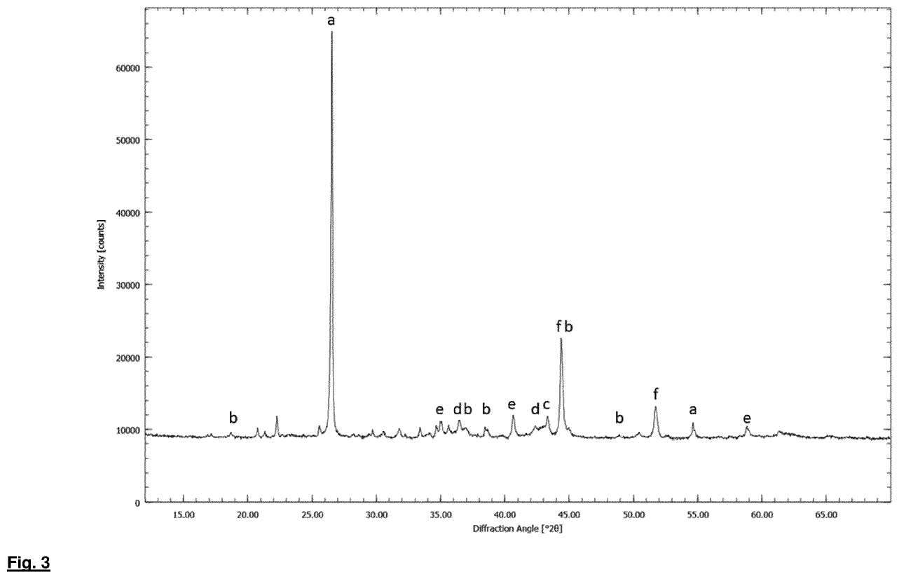

FIG. 2 depicts an exemplary continuous process (200) consistent with some embodiments of the disclosure. In some embodiments, a material (202) such as a black mass comprising nickel, cobalt, and manganese species is acid leached in continuously stirred reaction vessel (201) comprising an acidic aqueous solution at a pH less than 0. In some embodiments, the acid leaching is further carried out in one or more additional continuously stirred reaction vessels (203). In some embodiments, an oxidizing agent such as, for example, O₂ and/or N₂O is added (205) to a continuously stirred reaction vessel (204). In some embodiments, the acid leaching in the presence of an added oxidizing agent is further carried out in one or more additional continuously stirred reaction vessels (206). In some embodiments, the pH is adjusted up to a pH ranging from 1 to 2 with, for example, cathode active material and/or mixed hydroxide precipitate and a reducing agent such as, for example, SO₂ is introduced (208) to a continuously stirred reaction vessel (207). In some embodiments, the leaching in the presence of an added reducing agent is further carried out in one or more additional continuously stirred reaction vessels (209). In some embodiments, the obtained liquid phase (211) and a solid phase (210) are separated by a solid/liquid separation e.g. filtration, centrifugation, and/or sedimentation.

### EXAMPLES

The following examples are intended to be illustrative and are not meant in any way to limit the scope of the disclosure.

### ABBREVIATIONS

% percent
K₂CO₃ potassium carbonate
Na₂CO₃ sodium carbonate
Na₂B₄O₇ sodium tetraborate
p.a. grade pro analysis grade
n.d. not determined
wt % weight percent
NaOH sodium hydroxide
Li lithium
Ni nickel
Co cobalt
Mn manganese
Cu copper
Al aluminum
Fe iron
P phosphorus
F fluorine
Ca calcium

### Exemplary Elemental Analysis

Elemental analysis of solid samples was done by digestion in nitric acid and hydrochloric acid (feed samples and Examples 1 and 2) or digestion by K₂CO₃—Na₂CO₃/Na₂B₄O₇ fusion and dissolution of the fusion residue in hydrochloric acid (Examples 3 and 4).

The metals within the obtained sample solutions were determined by optical emission spectroscopy using an inductively coupled plasma (ICP-OES).

Elemental analysis of fluorine and fluoride was performed in accordance with DIN EN 14582:2016-12 with regard to the sample preparation for the overall fluorine content determination (waste samples); the detection method was an ion selective electrode measurement. DIN 38405-D4-2:1985-07 (water samples; digestion of inorganic solids with subsequent acid-supported distillation and fluoride determination using ion selective electrode).

Total carbon was determined by gas chromatography with a thermal conductivity detector of the gases obtained after combustion of the samples.

Sulfur was determined by catalytic combustion of the sample in an inert gas/oxygen atmosphere the sulfur is hereby converted to a mixture of SO₂ and SO₃. The formed SO₃ was subsequently reduced to SO₂ with copper granules. After drying and separation of the combustion gases, sulfur was detected and quantified as SO₂ via thermal conductivity or IR spectrometry.

### Black Mass

For the Examples provided below, a black mass was obtained by mechanical comminution of lithium ion batteries and subsequent separation of the black mass as a fine powder from the other constituents of the lithium ion batteries. The black mass was obtained by a process involving a pyrolysis of battery scrap. The material contains low amounts of sulfur. The metals analyzed are present as oxidic compounds like MnO, CoO, NiO, as salts like LiF, LiAlO₂, Li₂CO₃, and/or as zero oxidation state metals like nickel, cobalt, and copper. The carbon is elemental carbon mainly in the form of graphite with some soot or coke.

The composition of the black mass used in Examples 1, 2, and 4 is provided in Table 1.

TABLE 1
Composition of Black Mass used in Examples 1, 2, and 4

| Element | Weight Percent |
|---|---|
| Al | 6.3% |
| Ca | 0.1% |
| Co | 6.6% |
| Cu | 4.2% |
| Fe | 2.3% |
| K | 0.023% |
| Li | 3.5% |
| Mg | 0.16% |
| Mn | 7.0% |
| Na | 0.049% |
| Ni | 10.6% |
| Ti | 0.011% |
| Zn | 0.017% |
| F | 2.8% |

FIG. 3 depicts an XRD pattern of the black mass. In FIG. 3, “a” indicates graphite, “b” indicates nickel-cobalt-manganese, “c” indicates NiO, “d” indicates CoO, “e” indicates MnO, “f” indicates Ni, and the remaining reflections correspond to lithium salts and impurities.

The composition of the black mass used in Example 3 is given in Table 2.

TABLE 2
Composition of Black Mass used in Example 3:
Weight % of Element

| Ni | Co | Mn | Li | Al | Fe | Cu | C | F | S |
|---|---|---|---|---|---|---|---|---|---|
| 9.8 | 8.1 | 9.6 | 3.6 | 8.5 | 0.25 | 9.3 | 29.2 | 3.1 | 0.05 |

### Cathode Active Material

The cathode active material (CAM) used in Examples 1 and 2 was a commercially available CAM from BASF Corp called HEDTM NCM the composition of which was: 49.8 weight % Ni, 5.9 weight % Co, 2.6 weight % Mn, and 7.3 weight % Li.

### Mixed Hydroxide Precipitate

The mixed hydroxide precipitate (MHP) used in Examples 1 and 2 was a commercially available MHP produced by MCC's (Metallurgical Corporation of China) Ramu plant in PNG (Papua New Guinea) produced according to the following procedure: (1) HPAL (High pressure acid leaching) sulphuric acid leaching of limonite laterite ore fraction, (2) neutralization of the residual acid and Fe/Al removal by precipitation using CaCO₃ to increase the pH, (3) precipitation of the Ni and Co as MHP from the separated PLS using NaOH, and (4) a final precipitation step, using CaO—this 2nd stage precipitate is recycled back to autoclave discharge slurry neutralization, where the Ni and Co (and Mn) re-leaches.

The composition of the MHP is provided in Table 3.

TABLE 3

| Element | Weight Percent |
|---|---|
| Al | 0.24% |
| Ca | 0.15% |
| Co | 3.9% |
| Cu | 0.1% |
| Fe | 0.08% |
| K | 0.006% |
| Li | <0.001% |
| Mg | 1.46% |
| Mn | 5.3% |
| Na | 0.34% |
| Ni | 40.9% |
| Ti | 0.014% |
| Zn | 0.73% |
| F | n.d. |

### Example 1

In this example, black mass was contacted with an oxidizing acidic aqueous solution having a pH less than 6, and, subsequently, reduced with a reducing agent.

To a baffled 5 L beaker was added 1.5 L of water. Then, 450 g of H₂SO₄ was added while stirring followed by 300 g of black mass. The slurry was heated on a hot plate at 85° C. Air was sparged through the solution for 2.5 hours at 0.4 liters per minute (lpm) while maintaining a slurry temperature of about 85° C. Next, 52 g of cathode active material was added. The pH was then adjusted up to 1.5 by addition of mixed hydroxy precipitate. Subsequently, SO₂ was sparged through the solution at 0.13 lpm for 2 hours. The composition of the leach liquor is provided in Table 4.

TABLE 4

| Element | Concentration | |
|---|---|---|
| Al | 5,522 | ppm |
| Ca | 156 | ppm |
| Co | 9,848 | ppm |
| Cu | 4,426 | ppm |
| Fe | 2,189 | ppm |
| K | 22 | ppm |
| Li | 4,698 | ppm |
| Mg | 892 | ppm |
| Mn | 10,045 | ppm |
| Na | 293 | ppm |
| Ni | 42,560 | ppm |
| Ti | 20 | ppm |
| Zn | 588 | ppm |
| F | 2,482 | ppm |

The recovery of each of the elements Ni, Co, Mn, and Li was more that 99%. The recovery of Cu ranged from 98% to 99%, based on the analysis of the washed and dried leach residue.

### Example 2

In this example, black mass was contacted with an oxidizing acidic aqueous solution having a pH less than 6, and, subsequently, reduced with a reducing agent.

To a baffled 20 L polyvinylidene fluoride (PVDF) leach tank fitted with an internal electric heating coil was added 15.7 L of water. Then, 3 kg of 98 weight % aqueous H₂SO₄ was added while stirring followed by 2.2 kg of black mass. The slurry was heated at 85° C. Air was sparged through the solution for 4.5 hours at 4 lpm while maintaining a temperature of about 85° C. Next, 384 g of cathode active material was added. The pH was then adjusted up to 1.5 by addition of mixed hydroxy precipitate. Subsequently, SO₂ was sparged through the solution at 1.34 lpm for 2 hours. The solution was then filtered with a vacuum Nutche filter. The composition of the leach liquor is provided in Table 5.

TABLE 5

| Element | Concentration | |
|---|---|---|
| Al | 6,534 | ppm |
| Ca | 192 | ppm |
| Co | 9,893 | ppm |
| Cu | 4,550 | ppm |
| Fe | 2,427 | ppm |
| K | 46 | ppm |
| Li | 5,341 | ppm |
| Mg | 641 | ppm |
| Mn | 9,724 | ppm |
| Na | 269 | ppm |
| Ni | 36,720 | ppm |
| Ti | 34 | ppm |
| Zn | 446 | ppm |
| F | 2,909 | ppm |

The recovery of each of the elements Ni, Co, Mn, and Li was more that 99%, The recovery of Cu ranged from 98% to 99% based on the analysis of the washed and dried leach residue.

### Example 3 (Comparative)

In this example, black mass with the composition shown in Table 2 was leached with sulfuric acid. Air as oxidant was not introduced and sulfur dioxide reductant was not introduced.

In a reaction vessel 408 g of black mass was suspended in 1001 g of de-ionized water under an atmosphere of argon. To this mixture, 459 g of sulfuric acid (96 wt %) was slowly added over a period of about 45 min under vigorous stirring with a Rushton turbine. After the acid addition, the reactor was heated to 95° C. within about 60 min. The reactor was kept at this temperature for an additional 120 min. Next, the reactor was cooled to ambient temperature. The reactor content was filtered, washed with water, and dried to yield 157.7 g of a black solid. Analysis of the solid residues is provided in Table 6. The data of Table 6 shows that by acid dissolution of a black mass almost all metals constituting the cathode active material are dissolved while about 49% of the copper remains undissolved. The sulfur content in the residue remained low.

TABLE 6
Composition of dried solid residue

| | Weight % of Element | | | | | | | | |
|---|---|---|---|---|---|---|---|---|---|
| | Ni | Co | Mn | Li | Al | Fe | Cu | C | S |
| Reactor | 0.09 | 0.03 | 0.02 | 0.11 | 3.3 | 0.04 | 11.9 | 84 | 0.18 |
| Residue | | | | | | | | | |

### Example 4 (Comparative)

In this example, black mass with the composition shown in Table 1 was leached with sulfuric acid without introducing air as oxidant but in the presence of sulfur dioxide.

In a reaction vessel, 205 g of black mass was suspended in 563 g of de-ionized water under an atmosphere of argon. To this mixture, 266 g of sulfuric acid (96 wt %) was slowly added over a period of about 45 min under vigorous stirring with a Rushton turbine. Simultaneously, sulfur dioxide was fed to the reactor with a rate of 2.7 g/h. The gas leaving the reactor was fed to a scrubber filled with 1779 g of a solution of 50 g copper-(II)-sulfate pentahydrate in 1729 g of water. After the acid addition, the reactor was heated to 96° C. within 40 min. The reactor was kept at this temperature for an additional 205 min. Next, the sulfur dioxide addition was stopped and the reactor was cooled to ambient temperature. The reactor content was filtered, washed with water, and dried to yield 61.65 g of a black solid. 65 min after the start of the sulfuric acid and sulfur dioxide addition, the initially blue copper sulfate solution started to turn greenish and a dark precipitate was formed. The precipitate of the scrubber was also filtered washed with water and dried to yield 0.116 g of a dark solid. The analyses of the solid residues are given in Table 7.

TABLE 7
Composition of dried solid residues

| | Weight % of Element | | | | | | | | |
|---|---|---|---|---|---|---|---|---|---|
| | Ni | Co | Mn | Li | Al | Fe | Cu | C | S |
| Reactor | 0.34 | 0.28 | 0.19 | 0.19 | 3.3 | 0.11 | 12.5 | 79 | 4.1 |
| residue | | | | | | | | | |
| Scrubber | | | | | | | 83 | | 17 |
| residue | | | | | | | | | |

The data in Table 7 shows that an insoluble sulfur containing phase was formed during the reaction which was not present in the fed black mass (Table 2). The molar ratio of Cu:S in the reactor product was 3:2. The molar ratio of Cu:S in the scrubber product was about 12:5. Without wishing to be bound by theory, it is believed that under the reducing conditions in the presence of sulfur dioxide a mixture of copper-(II)-sulfide CuS and copper-(I)-sulfide Cu₂S was formed in the reactor. The scrubber product was Cu₂S with some adsorbed copper sulfate which could explain the excess copper. The amount of copper in the filter residue corresponds to about 92% of the copper.

Comparing Examples 1 and 2 with Example 3, it is believed that the subsequent reduction step with SO₂ may result in enhanced leaching performance such as, for example, improved copper yield.

Comparing Examples 1 and 2 with Example 4, it is believed that subsequent reduction with SO₂, as opposed to, for example, simultaneous reduction with SO₂, may result in enhanced leaching performance such as, for example, improved yield and reduced formation of potentially undesirable side-products such as copper-(II)-sulfide CuS and/or copper-(I)-sulfide Cu₂S.

Comparing Examples 1-4, it is believed that a method for leaching a material comprising one or more metals in a zero oxidation state and one or more chosen from metal oxides, metal hydroxides, and combinations thereof, the method comprising: contacting the material with an oxidizing acidic aqueous solution having a pH less than 6, and, subsequently, reducing the one or more chosen from metal oxides, metal hydroxides, and combinations thereof with a reducing agent; results in surprisingly improved leaching performance over, for example, methods omitting the contacting step, methods omitting the reducing step, and/or methods where the reducing step is not subsequent to the contacting step.

1. A method for leaching a material comprising one or more metals in a zero oxidation state and one or more chosen from metal oxides, metal hydroxides, and combinations thereof, wherein the method comprises:
contacting the material at a temperature ranging from 20° C. to 110° C. for a duration ranging from 10 minutes to 10 hours with an oxidizing acidic aqueous solution having a pH less than 6 and comprising one or more acids chosen from HCl, H₂SO₄, CH₃SO₃H, HNO₃, and combinations thereof, and further comprising one or more chosen from O₂, N₂O, and combinations thereof, and
subsequently reducing the one or more chosen from metal oxides, metal hydroxides, and combinations thereof at a temperature ranging from 20° C. to 100° C. for a duration ranging from 10 minutes to 10 hours with a reducing agent chosen from SO₂, metabisulfite salts, bisulfite salts, thiosulfate salts, dithionate salts, H₂O₂, H₂, and combinations thereof.

2. The method according to claim 1, wherein the oxidizing acidic aqueous solution comprises H₂SO₄ and further comprises O₂, N₂O, or combinations thereof.

3. The method according to claim 1, wherein the reducing agent is SO₂, and SO₂ is sparged through the solution at a rate of up to 20% of the total volume of the solution per minute.

4. The method according to claim 1, wherein the material is a lithium ion battery material comprising one or more chosen from black mass, cathode active material, cathodes, cathode active material precursors, and combinations thereof, and/or wherein the material comprises one or more chosen from nickel, cobalt, manganese, and combinations thereof.

5. The method according to claim 1, wherein the one or more metals in a zero oxidation state is chosen from nickel, cobalt, copper, aluminum, iron, manganese, rare earth metals, and combinations thereof, and/or wherein the metal oxides are chosen from nickel oxides, cobalt oxides, copper oxides, aluminum oxide, iron oxides, manganese oxides, rare earth oxides, and combinations thereof, and/or wherein the metal hydroxides are chosen from nickel hydroxides, cobalt hydroxides, copper hydroxides, aluminum hydroxide, iron hydroxides, manganese hydroxides, rare earth hydroxides, and combinations thereof.

6. The method according to claim 1, wherein the material comprises:
from 0.1 weight percent to 10 weight percent lithium,
from 0 weight percent to 60 weight percent nickel,
from 0 weight percent to 20 weight percent cobalt,
from 0 weight percent to 20 weight percent copper,
from 0 weight percent to 20 weight percent aluminum,
from 0 weight percent to 20 weight percent iron, and
from 0 weight percent to 20 weight percent manganese;
wherein each weight percent is by total weight of the material, with the proviso that the content of at least one of nickel, cobalt, and manganese is more than 0 weight percent.

7. The method according to claim 1, wherein the material, or a precursor thereof, is pyrolyzed prior to leaching.

8. The method according to claim 1, wherein the oxidizing acidic aqueous solution comprises O₂, the O₂ being provided as air, and the air being sparged through the solution at a rate corresponding to up to 20% of the total volume of the solution of O₂ being sparged through the solution per minute.

9. The method according to claim 1, further comprising adding an additional metal oxide and/or metal hydroxide after the contacting step and before the reducing step, and/or wherein contacting the material with an oxidizing acidic aqueous solution having a pH less than 6 causes a formation of hydrogen gas, and wherein after the formation of hydrogen gas, adding an oxidizing agent chosen from O₂, N₂O, and combinations, and/or wherein the oxidizing acidic aqueous solution has a concentration of acid ranging from 18 mol/L to 0.0001 mol/L.

10. The method according to claim 1, wherein, subsequent to the contacting step, the method further comprises adding an additional material comprising one or more chosen from metal oxides, metal hydroxides, metal carbonates, metal bicarbonate and combinations thereof.

11. A method comprising:
leaching a material according to claim 1 to obtain an aqueous solution comprising metal ions, and
separating the metal ions to obtain at least one essentially pure metal ion solution and/or at least one essentially pure solid metal ion salt.

12. A method comprising:
mechanically comminuting at least one material chosen from a lithium ion battery, lithium ion battery waste, lithium ion battery production scrap, lithium ion cell production scrap, lithium ion cathode active material, and combinations thereof to obtain a black mass, and
subjecting the black mass to the method according to claim 1, optionally further comprising subjecting the at least one material to a heat treatment step.

13. The method according to claim 1, wherein, subsequent to the contacting step, the method further comprises adding a base, preferably wherein the base is chosen from CaO, a hydroxide salt, a carbonate salt, and combinations thereof, optionally wherein the hydroxide salt is chosen from LiOH, NaOH, KOH, NH₄OH, Ca(OH)₂, Ni(OH)₂, Co(OH)₂, Mn(OH)₂ and combinations thereof.

14. The method according to claim 1, wherein the oxidizing acidic aqueous solution further comprises hydrogen peroxide, provided that the one or more chosen from metal oxides or metal hydroxides comprising nickel cobalt or manganese contain these metals in an oxidation state of +2.

15. The method according to claim 10, wherein the additional material comprises nickel and/or cobalt, optionally wherein the additional material comprises cathode active material.
